(19) United States
(12) Patent Application Publication
(10) Pub. No.: US 2013/0257702 A1
(43) Pub. Date: Oct. 3, 2013

(54) IMAGE PROJECTING APPARATUS, IMAGE PROJECTING METHOD, AND COMPUTER PROGRAM PRODUCT

(71) Applicant: JVC KENWOOD CORPORATION, Yokohama-shi (JP)

(72) Inventor: Kenichiro OZEKI, Kawasaki-shi (JP)

(73) Assignee: JVC KENWOOD Corporation, Yokohama-shi (JP)

(21) Appl. No.: 13/851,632

(22) Filed: Mar. 27, 2013

(30) Foreign Application Priority Data
Mar. 29, 2012 (JP) 2012-075441

(51) Int. Cl. G09G 3/36

(52) U.S. Cl. CPC G09G 3/36
USPC 345/87

(57) ABSTRACT

An image projecting apparatus includes: a receiving unit that receives a projection target image; a generating unit that generates an entire image including the projection target image received by the receiving unit; a projecting unit that projects the entire image generated by the generating unit; a detecting unit that detects a distribution of distances up to projection portions to which the entire image projected by the projecting unit is actually projected; and a specifying unit that specifies a projection target plane to which the projection target image is projected based on the distribution of the distances detected by the detecting unit. The generating unit generates the entire image so that the entire projection target image included in the entire image projected by the projecting unit is projected to the entire projection target plane specified by the specifying unit.

### CROSS-REFERENCE TO RELATED APPLICATIONS

The present application claims priority to and incorporates by reference the entire contents of Japanese Patent Application No. 2012-075441 filed in Japan on Mar. 29, 2012.

### BACKGROUND OF THE INVENTION

1. Field of the Invention

The present invention relates to an image projecting apparatus, an image projecting method, and a computer program product.

2. Description of the Related Art

There are known various technologies for correcting an image projected to a projection plane based on a rugged state of the projection plane to project a desired image to the projection plane. For example, Japanese Patent Application Laid-open No. 2001-61121 discloses a projector apparatus that corrects distortion of an image according to the shape of a projected plane (projection plane) and corrects distortion of a display image to be projected to an uneven projection plane or a curved projection plane.

The projector apparatus disclosed in Japanese Patent Application Laid-open No. 2001-61121 includes a video input unit that inputs an original image; a projection plane acquiring unit that calculate an azimuth angle, an inclination angle, and a distance of the projection plane from a normal vector of the projection plane and acquires a three-dimensional shape of the projection plane; a video correcting unit that performs inclination correction and scaling correction on the original according to the shape of the projective plane; and a video output unit that outputs and projects a corrected image.

In the invention disclosed in Japanese Patent Application Laid-open No. 2001-61121, however, a desired image may not be appropriately displayed depending on a state of a space in the projection direction of an image in some cases. In the invention disclosed in Japanese Patent Application Laid-open No. 2001-61121, for example, when a presenter is moving in a space between the projector apparatus and the projection plane, an image is projected to the presenter, and thus a desired image may not be appropriately displayed in some cases. For this reason, it is desirable to provide a technology for appropriately displaying a desired image according to the state of the space in the projection direction of the image.

### SUMMARY OF THE INVENTION

It is an object of the present invention to at least partially solve the problems in the conventional technology.

To solve the above described problems and achieve the object, according to an aspect of the present invention, an image projecting apparatus includes: a receiving unit that receives a projection target image; a generating unit that generates an entire image including the projection target image received by the receiving unit; a projecting unit that projects the entire image generated by the generating unit; a detecting unit that detects a distribution of distances up to projection portions to which the entire image projected by the projecting unit is actually projected; and a specifying unit that specifies a projection target plane to which the projection target image is projected based on the distribution of the distances detected by the detecting unit, and the generating unit generates the entire image so that the entire projection target image included in the entire image projected by the projecting unit is projected to the entire projection target plane specified by the specifying unit.

According to another aspect of the present invention, the specifying unit specifies a plane or an incurve plane present in a direction in which the projecting unit projects the entire image based on the distribution of the distances detected by the detecting unit and specifies, as the projection target plane, a plane or an incurve plane which is extracted from the specified plane or the specified incurve plane and in which an entire partial image having an area equal to or greater than a predetermined ratio in the entire image is projected to an entirety.

According to still another aspect of the present invention, the specifying unit specifies a plane or an incurve plane present in a direction in which the projecting unit projects the entire image based on the distribution of the distances detected by the detecting unit and specifies, as the projection target plane, a plane or an incurve plane which is extracted from the specified plane or the specified incurve plane and in which an entire partial image having a maximum area in the entire image is projected to an entirety.

According to still another aspect of the present invention, the specifying unit specifies a plane or an incurve plane present in a direction in which the projecting unit projects the entire image based on the distribution of the distances detected by the detecting unit and specifies, as the projection target plane, a plane or an incurve plane which is extracted from the specified plane or the specified incurve plane and which is closest.

According to still another aspect of the present invention, in the entire image generated by the generating unit, a portion other than a portion indicating the projection target image received by the receiving unit is an image, such as a black image, which is not displayed by the projection.

According to still another aspect of the present invention, an image projecting method includes: receiving a projection target image; generating an entire image including the projection target image received in the receiving of the projection target image; projecting the entire image generated in the generating of the entire image; detecting a distribution of distances up to projection portions to which the entire image projected in the projecting of the entire image is actually projected; and specifying a projection target plane to which the projection target image is projected based on the distribution of the distances detected by the detecting of the distribution of distances, and in the generating of the entire image, the entire image is generated so that the entire projection target image included in the entire image projected in the projecting of the entire image is projected to the entire projection target plane specified in the specifying of the projection target plane.

According to still another aspect of the present invention, a computer program product causing a computer to function as: a receiving unit that receives a projection target image; a generating unit that generates an entire image including the projection target image received by the receiving unit; a projecting unit that projects the entire image generated by the generating unit; a detecting unit that detects a distribution of distances up to projection portions to which the entire image projected by the projecting unit is actually projected; and a specifying unit that specifies a projection target plane to which the projection target image is projected based on the distribution of the distances detected by the detecting unit, and the generating unit generates the entire image so that the entire projection target image included in the entire image projected by the projecting unit is projected to the entire projection target plane specified by the specifying unit.

The above and other objects, features, advantages and technical and industrial significance of this invention will be better understood by reading the following detailed description of presently preferred embodiments of the present invention, when considered in connection with the accompanying drawings.

### BRIEF DESCRIPTION OF THE DRAWINGS

FIG. 1 is a block diagram illustrating a hardware configuration of an image projecting apparatus according to a first embodiment of the present invention;

FIG. 2 is a diagram schematically illustrating a state in which the image projecting apparatus projects an image toward a projection plane;

FIG. 3 is a block diagram illustrating functions of the image projecting apparatus according to the first embodiment of the present invention;

FIG. 4A is a diagram illustrating a projectable plane, before a presenter overlaps;

FIG. 4B is a diagram illustrating the projectable plane, when the presenter overlaps;

FIG. 4C is a diagram illustrating a projection target plane extracted from the projection target plane, when the presenter overlaps;

FIG. 5A is a diagram illustrating a projectable plane, after the presenter has moved;

FIG. 5B is a diagram illustrating a projection target plane, after the presenter has moved;

FIG. 6A is a diagram illustrating a state in which an entire image is divided to a plurality of blocks;

FIG. 6B is a diagram illustrating an extractable portion in the entire image;

FIG. 7A is a diagram illustrating a plurality of extraction portion candidates which can be extracted from the extractable portion;

FIG. 7B is a diagram illustrating a state in which the exacted portion is selected from the extraction portion candidates in the entire image;

FIG. 8 is a flowchart illustrating an image projecting process performed by the image projecting apparatus according to the first embodiment of the present invention;

FIG. 9A is a diagram illustrating a plurality of projectable planes;

FIG. 9B is a diagram illustrating a projection target plane extracted from the selected projectable plane;

FIG. 10 is a flowchart illustrating an image projecting process performed by an image projecting apparatus according to a second embodiment of the present invention;

FIG. 11A is a diagram illustrating a state in which the entire image is divided into a large number of small blocks;

FIG. 11B is a diagram illustrating a state in which the entire image is divided into a small number of large blocks;

FIG. 12A is a diagram illustrating a circular projectable plane; and

FIG. 12B is a diagram illustrating a circular projection target plane.

### DETAILED DESCRIPTION OF THE PREFERRED EMBODIMENTS

Hereinafter, an image projecting apparatus according to embodiments of the present invention will be described with reference to the drawings.

### First Embodiment

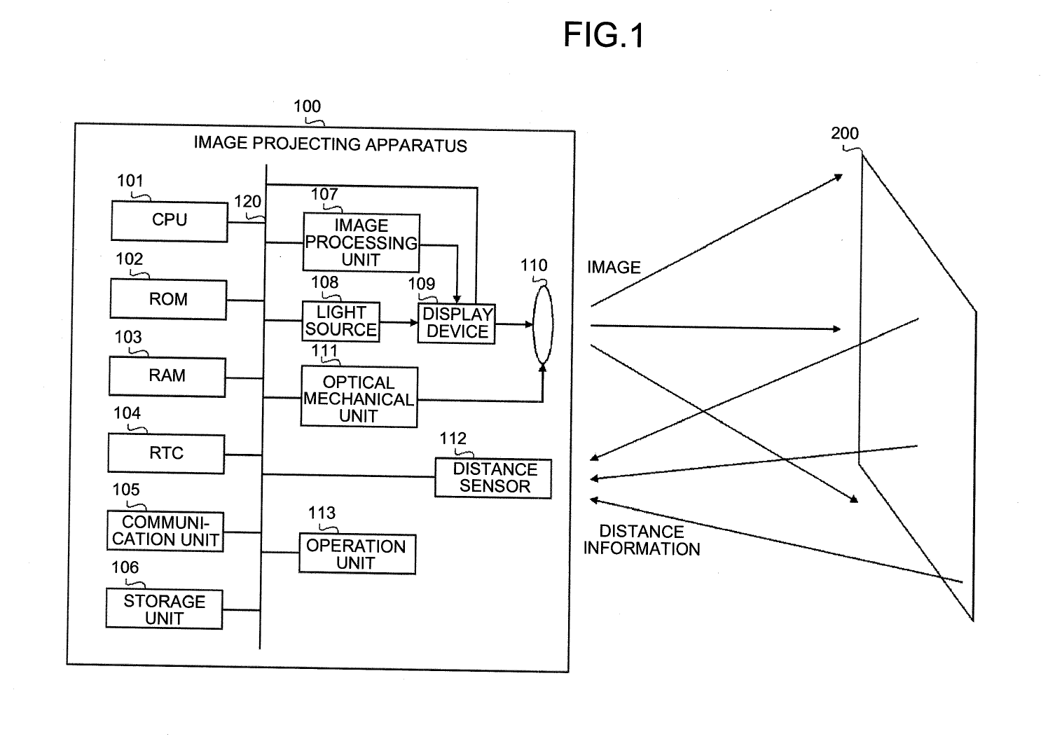

First, the configuration of an image projecting apparatus 100 according to a first embodiment will be described with reference to FIG. 1. The image projecting apparatus according to the present invention is not limited to the image projecting apparatus 100 illustrated in FIG. 1. For example, the present invention may be applied to an image projecting apparatus in which various apparatuses are incorporated in the image projecting apparatus 100. Alternatively, the present invention may be appropriately applied to an image projecting apparatus in which various apparatuses are excluded from the image projecting apparatus 100.

First, the physical configuration of the image projecting apparatus 100 will be described with reference to FIG. 1. As illustrated in FIG. 1, the image projecting apparatus 100 includes a CPU (Central Processing Unit) 101, a ROM (Read Only Memory) 102, a RAM (Random Access Memory) 103, an RTC (Real Time Clock) 104, a communication unit 105, a storage unit 106, an image processing unit 107, a light source 108, a display device 109, a projecting lens 110, an optical mechanical unit 111, a distance sensor 112, and an operation unit 113. These constituent units of the image projecting apparatus 100 are connected to one another via a bus 120.

The image projecting apparatus 100 is, for example, an apparatus that projects an image toward a screen 200. The image projected by the image projecting apparatus 100 may be a still image or a moving image. The image projected by the image projecting apparatus 100 may be an image supplied from an external apparatus to the image projecting apparatus 100 or may be an image stored in the storage unit 106 of the image projecting apparatus 100.

The CPU 101 controls all of the behaviors of the image projecting apparatus 100. The CPU 101 operates according to a computer program stored in the ROM 102 and uses the RAM 103 as a work area.

The ROM 102 stores the computer program or data used to control all of the behaviors of the image projecting apparatus 100.

The RAM 103 functions as the work area of the CPU 101. That is, the CPU 101 temporarily writes a computer program or data in the RAM 103 and appropriately refers to the computer program or the data.

The RTC 104 is a timing device that includes a crystal oscillator, an oscillation circuit, or the like and supplies a clock to the CPU 101 or the like. Power is supplied to the RTC 104 from an internal battery, the RTC 104 continues to operate even when the image projecting apparatus 100 is turned off.

The communication unit 105 is an interface that mutually communicates with an external apparatus of the image projecting apparatus 100. The communication unit 105 receives information (hereinafter, appropriately and simply referred to as an “image”) or the like indicating an image from the external apparatus of the image projecting apparatus 100. The communication unit 105 includes, for example, an HDMI (High-Definition Multimedia Interface) terminal, a USB (Universal Serial Bus) terminal, a memory card slot, and an NIC (Network Interface Card).

The storage unit 106 stores the image or the like that the communication unit 105 receives from the external apparatus of the image projecting apparatus 100. The image projecting apparatus 100 includes an internal hard disk or an internal memory as the storage unit 106. Further, the image projecting apparatus 100 may include a DVD optical disk driver or a memory card slot on which a DVD-ROM (Digital Versatile Disk-Read Only Memory), a memory card, or the like storing a still image, a moving image, or the like is mounted, instead of the storage unit 106.

The image processing unit 107 generates an image signal indicating an image displayed on the display device 109 under the control of the CPU 101. The image processing unit 107 supplies the generated image signal to the display device 109.

The light source 108 emits light toward the display device 109 under the control of the CPU 101. The light source 108 is, for example, a light source that emits light of a halogen lamp, a xenon lamp, or the like or laser light. The light emitted from the light source 108 is transmitted through or reflected from the display device 109, so that an image displayed on the display device 109 is projected via the projecting lens 110.

The display device 109 displays an image based on an image signal supplied from the image processing unit 107. For example, the display device 109 includes a transmissive liquid crystal display element that transmits the light from the light source 108 or a reflective liquid crystal display element that reflects the light from the light source 108. For example, the display device 109 includes a plurality of pixels arrayed in a matrix form. Each pixel includes three areas corresponding to the three primary colors of light of RGB. Each area includes an optical filter and a liquid crystal layer corresponding to each color. Colors, brightness, or the like of the light emitted by transmitting or reflected from the display device 109 is controlled according to the image signal supplied from the image processing unit 107. The display device 109 controls the amount of light emitted from the light source 108 and supplied to the projecting lens 110 for each pixel and each primary color according to the image signal supplied from the image processing unit 107 under the control of the CPU 101. The light transmitted through or reflected from the display device 109 is projected light.

The projecting lens 110 forms an image formed by the projected light transmitted through or reflected from the display device 109 on a plane (hereinafter, a “plane of the screen 200 on the side of the image projecting apparatus 100” is appropriately and simply referred to as the “screen 200”) of the screen 200 on the side of the image projecting apparatus 100.

The optical mechanical unit 111 controls the position or the like of the projecting lens 110 based on the distance between the image projecting apparatus 100 and the screen 200, or the like, under the control of the CPU 101 so that the image is formed on the screen 200. The optical mechanical unit 111 includes an actuator.

The distance sensor 112 measures the distance between the image projecting apparatus 100 and a projection portion to which the image projected from the image projecting apparatus 100 is actually projected under the control of the CPU 101. In the case, for example, an obstacle such as a presenter is not present between the image projecting apparatus 100 and the screen 200; the distance sensor 112 measures the distance between the image projecting apparatus 100 and each portion of the screen 200. In the case, for example, an obstacle such as a presenter is present between the image projecting apparatus 100 and the screen 200; the distance sensor 112 measures the distance between the image projecting apparatus 100 and each portion of the surface of the obstacle. The distance sensor 112 is typically installed in a proximity of the projecting lens 110.

A distance sensor configured to measure a distance in a plurality of directions may be employed as the distance sensor 112. For example, as the distance sensor 112, a sensor that includes a plurality of distance sensors measuring distances in a plurality of different directions may be employed, or a sensor that includes a mechanism capable of varying a direction in which a distance sensor measures a distance may be employed. For example, the distance sensor 112 includes a light-emitting unit that emits light toward a projection portion and a light-receiving unit that receives infrared light reflected from the projection portion. The light-emitting unit is, for example, an LED or a laser diode. The light-receiving unit is, for example, a PSD (Position Sensing Device) or a CMOS (Complementary Metal Oxide Semiconductor).

The operation unit 113 receives various kinds of operations from a user of the image projecting apparatus 100. The operation unit 113 includes a button, a key, a lever, and a volume switch. The operation unit 113 generates a signal based on an operation in response to the operation received by the button, the key, the lever, or the volume switch and supplies the signal to the CPU 101.

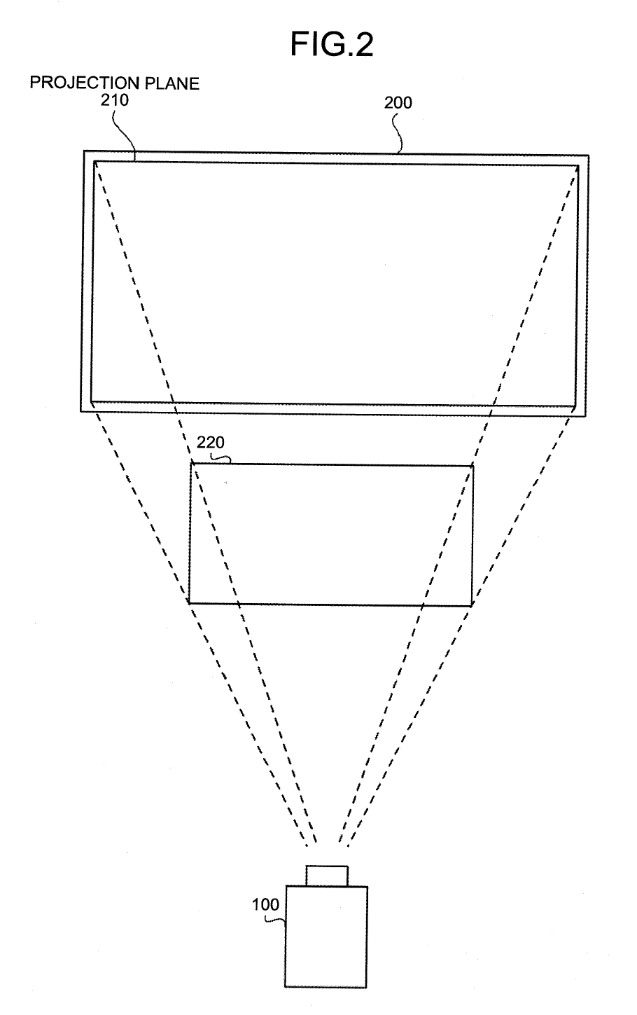

Hereinafter, a state in which an image is projected from the image projecting apparatus 100 to a projection plane 210 will be described with reference to FIG. 2.

First, in the first embodiment, for example, an image projected by the image projecting apparatus 100 is assumed to be a rectangular image in which the number pixels in the horizontal direction is greater than the number of pixels in a perpendicular direction (hereinafter, referred to as a “vertical direction”) orthogonal to the horizontal direction and the entire rectangular image is assumed to be projected to the screen 200. Here, when an obstacle is not present between the image projecting apparatus 100 and the screen 200, a plane on the screen 200 on which the projected image is displayed is referred to as a projection plane 210.

That is, in the first embodiment, as illustrated in FIG. 2, the image projecting apparatus 100 projects an image such that the image is outspread from the image projecting apparatus 100 to the projection plane 210, and thus the entire image is displayed on the entire projection plane 210 on the screen 200. Here, the image projected from the image projecting apparatus 100 is a flux of light beams corresponding to the respective pixels and the respective colors. The flux of light beams is outspread from the projecting lens 110 of the image projecting apparatus 100 to the projection plane 210. Further, the respective light beams are also outspread from the projecting lens 110 of the image projecting apparatus 100 to the projection plane 210.

Here, the image projecting apparatus 100 adjusts the focus of the projecting lens 110 so that the image indicated by the projected light projected from the projecting lens 110 can be formed on the projection plane 210. Further, projecting of the image from the image projecting apparatus 100 to the entire projection plane 210 is the same as projecting of the image from the image projecting apparatus 100 to an entire projection plane 220. That is, in the first embodiment, in the image projecting apparatus 100, a projection field angle in the horizontal direction is constant and a projection field angle in the vertical direction is also constant.

That is, even when a position to which each light beam is projected is a position located before and after the projection plane 210 formed on the surface of the screen 200, the focus of the projecting lens 110 is adjusted based on the distance between the projecting lens 110 and the projection plane which is measured by the distance sensor 112. In the example of FIG. 2, the separate projection plane 220 is provided on the side of the image projecting apparatus 100 from the projection plane 210. Even in this case, the distance sensor 112 measures the distance between the image projecting apparatus 100 and the projection plane 220 so that the focused image can be projected to the projection plane 220.

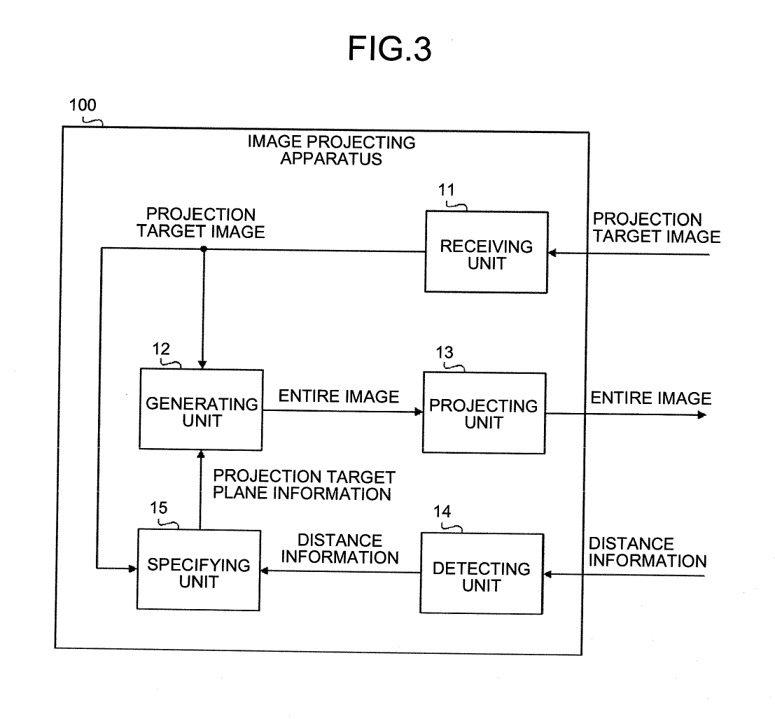

Next, the basic functions of the image projecting apparatus 100 according to the first embodiment will be described with reference to FIG. 3. As illustrated in FIG. 3, the image projecting apparatus 100 functionally includes a receiving unit 11, a generating unit 12, a projecting unit 13, a detecting unit 14, and a specifying unit 15.

The receiving unit 11 receives an input of a projection target image. The projection target image may be a moving image or a still image. Further, the projection target image may be a monochrome image or a color image. The projection target image is, for example, various kinds of contents images. For example, the receiving unit 11 includes the communication unit 105.

The generating unit 12 generates an entire image including the projection target image received from the receiving unit 11. The entire image is an image to be projected by the image projecting apparatus 100. The entire image is an image indicating the entire projection target image or an image partially including the projection target image by reducing or modifying the projection target image. For example, the generating unit 12 includes the CPU 101 and the image processing unit 107.

The projecting unit 13 projects the entire image generated by the generating unit 12. For example, the projecting unit 13 includes the CPU 101, the light source 108, the display device 109, the projecting lens 110, and the optical mechanical unit 111.

The detecting unit 14 detects a distribution of the distances between the image projecting apparatus and the projection portions to which the entire image projected by the projecting unit 13 is actually projected. A direction in which the projected light travels depends on a portion to which the projected light corresponds in the entire image. That is, the direction in which the projected light travels is slightly different for each of partial images constituting the entire image. Accordingly, the detecting unit 14 detects the projection distance for each partial image and detects the distribution of the projection distances for the respective partial images. For example, the detecting unit 14 includes the CPU 101 and the distance sensor 112. Even in a stage before the image is projected, the detecting unit 14 detects a distance by which the image is expected to be projected when the image is projected. Hereinafter, the distance by which the image is expected to be projected is also inclusively referred to as a projection distance.

The specifying unit 15 specifies a projection target plane to which the projection target image is projected based on the distribution of the projection distances detected by the detecting unit 14. The projection target plane preferably has a similar outer shape to that of the projection target image. For example, the specifying unit 15 specifies projectable planes present in the projection direction of the entire image and specifies an optimum projection target plane from the specified projectable planes. For example, the specifying unit 15 includes the CPU 101.

Here, the generating unit 12 generates the entire image including the entire projection target image on the projection target plane specified by the specifying unit 15. For example, the generating unit 12 generates an image in which the entire projection target image is arrayed in a portion corresponding to the projection target plane in the entire image.

When projecting the image which is generated by the generating unit 12 and in which the entire projection target image is arrayed in the portion corresponding to the projection target plane in the entire image, the display device 109 performs the following process on the pixels other than the projection target image. In a case the display device 109 is a transmissive liquid crystal display element, the display device 109 displays the pixels other than the projection target image as a non-transmission black portion. In a case the display device 109 is a reflective liquid crystal display element, the display device 109 displays the pixels other than the projection target image as a non-reflection black portion.

Next, an example will be described in which a projection target plane 240 has moved on the screen 200 when a presenter 400 as an example of the obstacle present in the space between the image projecting apparatus 100 and the screen 200 overlaps the lower left portion of the screen 200 in a drawing and has moved to a position overlapping the lower right portion of the screen 200 in a drawing.

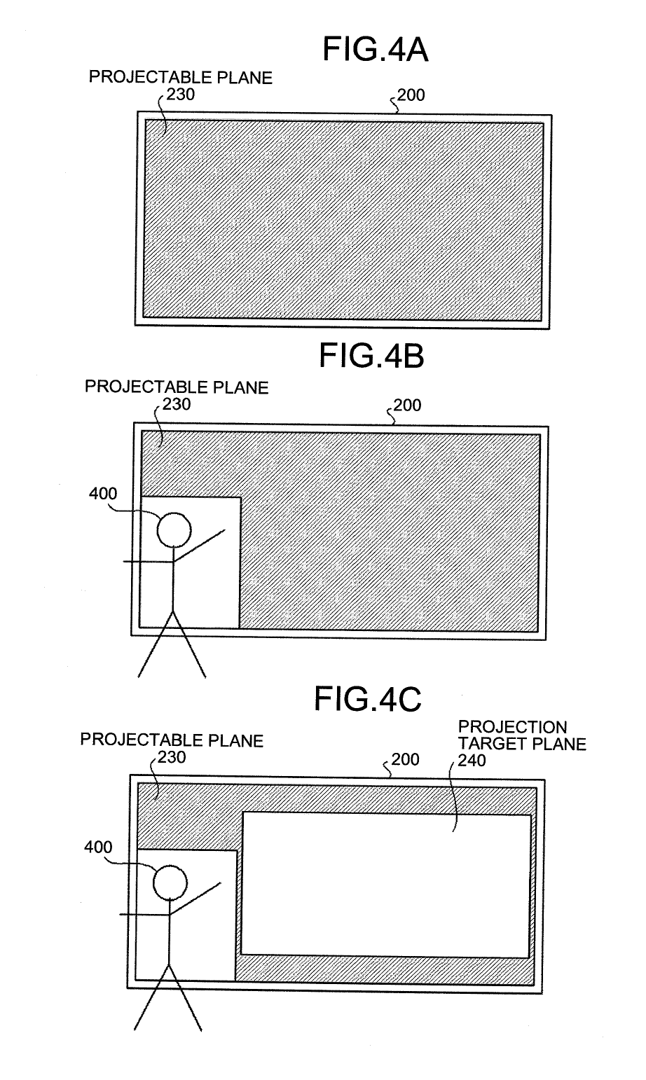

FIG. 4A is a diagram illustrating a projectable plane 230 when the image projecting apparatus 100 projects an image to the screen 200 and an obstacle such as the presenter 400 is not present between the image projecting apparatus 100 and the screen 200. In this case, the projection plane 220 and the projectable plane 230 are the same.

FIG. 4B is a diagram illustrating the projectable plane 230 when the presenter 400 overlaps the screen 200. First, when the presenter 400 is present in the space between the image projecting apparatus 100 and the screen 200, the image projecting apparatus 100 may not appropriately project an image to a portion shaded by the presenter 400 in the screen 200 when viewed from the image projecting apparatus 100. Further, since the presenter 400 is moving his or her hands or legs to give a presentation, it is considered that the image projecting apparatus 100 may not appropriately project the image to a portion in the periphery of the portion shaded by the presenter 400 in the screen 200 when viewed from the image projecting apparatus 100.

Accordingly, the image projecting apparatus 100 specifies a plane excluding the portion shaded by the presenter 400 in the screen 200 and the portion adjacent to the shaded portion as the projectable plane 230. FIG. 4B illustrates an example in which the hatched portion excluding the lower left portion of the screen 200 in the drawing is specified as the projectable plane 230.

FIG. 4C is a diagram illustrating the projection target plane 240 extracted from the projectable plane 230, when the presenter 400 overlaps the screen 200. In the first embodiment, the projection target plane 240 is a plane that is extracted from the projectable plane 230 and has the maximum size with the same outer shape as that of the projection target image. A method by which the image projecting apparatus 100 extracts the projection target plane 240 from the projectable plane 230 will be described below.

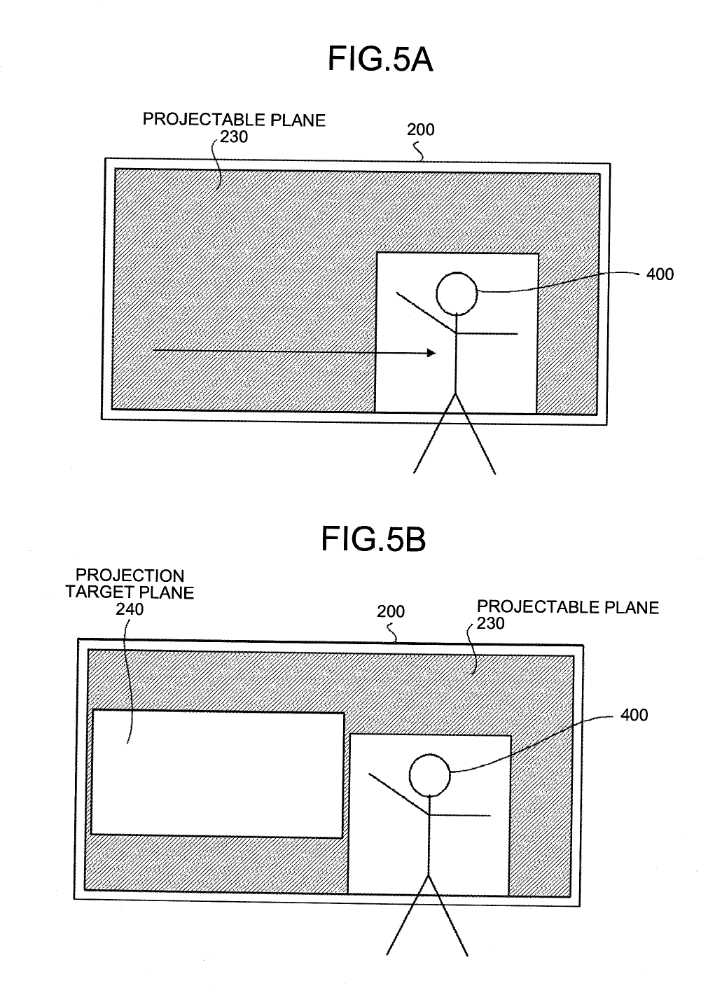

FIG. 5A is a diagram illustrating the projectable plane 230, when the presenter 400 has moved. FIG. 5A illustrates an example in which a portion excluding a lower portion on the right side from the middle of the screen 200 in the drawing is specified as the projectable plane 230.

FIG. 5B is a diagram illustrating the projection target plane 240 extracted from the projectable plane 230, when the presenter 400 has moved. The projection target plane 240 is a plane that is extracted from the projectable plane 230 and has the maximum size with the same outer shape as that of the projection target image. However, as illustrated in FIGS. 4C and 5B, the projectable plane 230 is different in before and after movement of the presenter 400. Accordingly, as illustrated in FIGS. 4C and 5B, the projection target plane 240 extracted from the projectable plane 230 is also different in before and after the movement of the presenter 400.

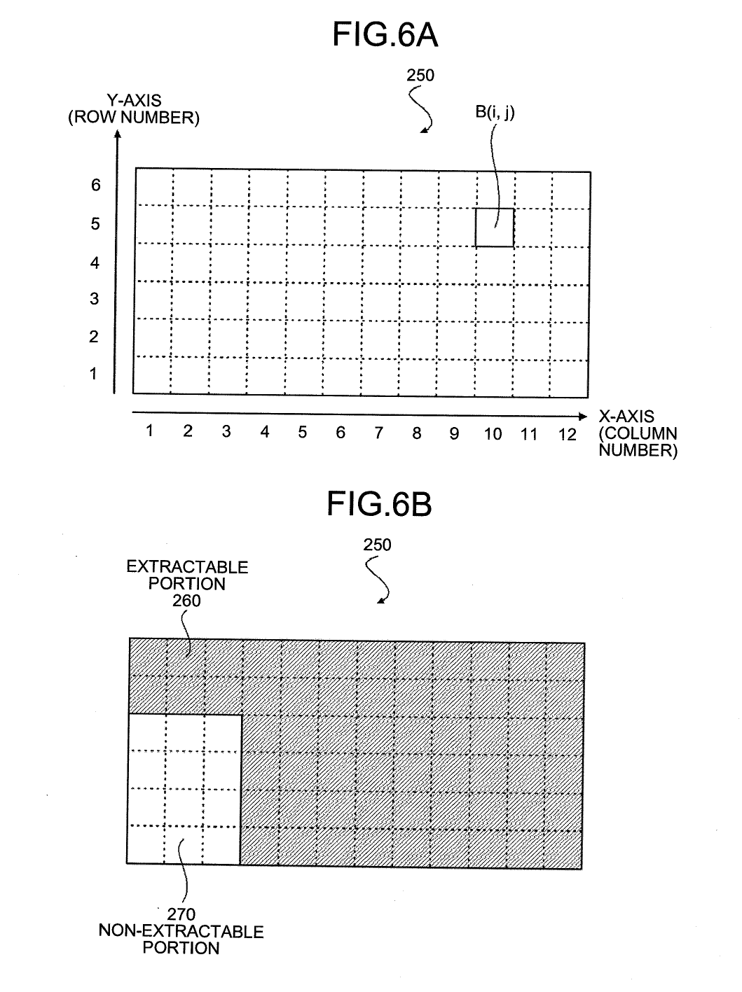

Next, a method of specifying the projectable plane 230 will be described with reference to FIGS. 6A and 6B.

As described above, the image projecting apparatus 100 projects an entire image 250 toward the outside of the image projecting apparatus 100 so that the entire image 250 may be projected to the entire projection plane 210. Accordingly, the image projecting apparatus 100 detects the distribution of the distances by which the respective portions of the entire image 250 are projected.

In the first embodiment, as illustrated in FIG. 6A, for example, the image projecting apparatus 100 divides the entire image 250 into “12×=72” blocks (areas) and detects the projection distance for each block. In FIG. 6A, the axis extending in the horizontal direction is referred to as an X axis and the axis extending in the vertical direction is referred to as a Y axis. The coordinates of the blocks in the X axis are indicated by column numbers and the coordinates of the blocks in the Y axis are indicated by the row numbers. One block is specified by B (i, j) that has a column number i (where i is a natural number from 1 to 12) and a row number j (where j is a natural number from 1 to 6).

Here, a direction in which the image is projected is different for each block. Accordingly, the distance sensor 112 of the image projecting apparatus 100 detects the projection distance for each block. Here, the projection distance of a block specified by B (i, j) is referred to as D (i, j). When a difference between the projection distance detected for a first block and the projection distance detected for a second block adjacent to the first block is equal to or less than a predetermined threshold value, the image projecting apparatus 100 considers the projection portion of the first block and the projection portion of the second block as continuous portions on the same plane.

For example, the image projecting apparatus 100 performs a process of determining whether a difference between D (i, j) and D (i-1, j) is equal to or less than a predetermined threshold value and a difference between D (i, j) and D (i, j-1) is equal or less than the predetermined value in a block specified by B (i, j) on all of the combinations (12×6=72 combinations) of i (where i=1 to 12) and j (where j=1 to 6). The image projecting apparatus 100 considers images corresponding to two respective blocks in which the difference between the projection distances is equal to or less than the predetermined threshold value to be projected to the same continuous plane. Then, the image projecting apparatus 100 specifies the plane to which the image corresponding to each of the number of blocks equal to or greater than a predetermined number is projected as the projectable plane 230. The number of blocks equal to or greater than the predetermined number is, for example, 30% or more of all the blocks.

In FIG. 6B, an image portion corresponding to the projectable plane 230 in the entire image 250 is indicated as an extractable portion 260 and an image portion other than the extractable portion 260 in the entire image 250 is indicated as a non-extractable portion 270. Here, FIG. 6B illustrates an example in which a portion constituted by “3×4=12” blocks in the lower left side of the drawing is the non-extractable portion 270 and a portion constituted by “72−12=60” blocks excluding the non-extractable portion 270 is the extractable portion 260. In FIG. 6B, the extractable portion 260 is illustrated by hatching. Here, the image projecting apparatus 100 specifies the plane in which the entire projected image is projected to the entire plane as the projectable plane 230 from the extractable portion 260.

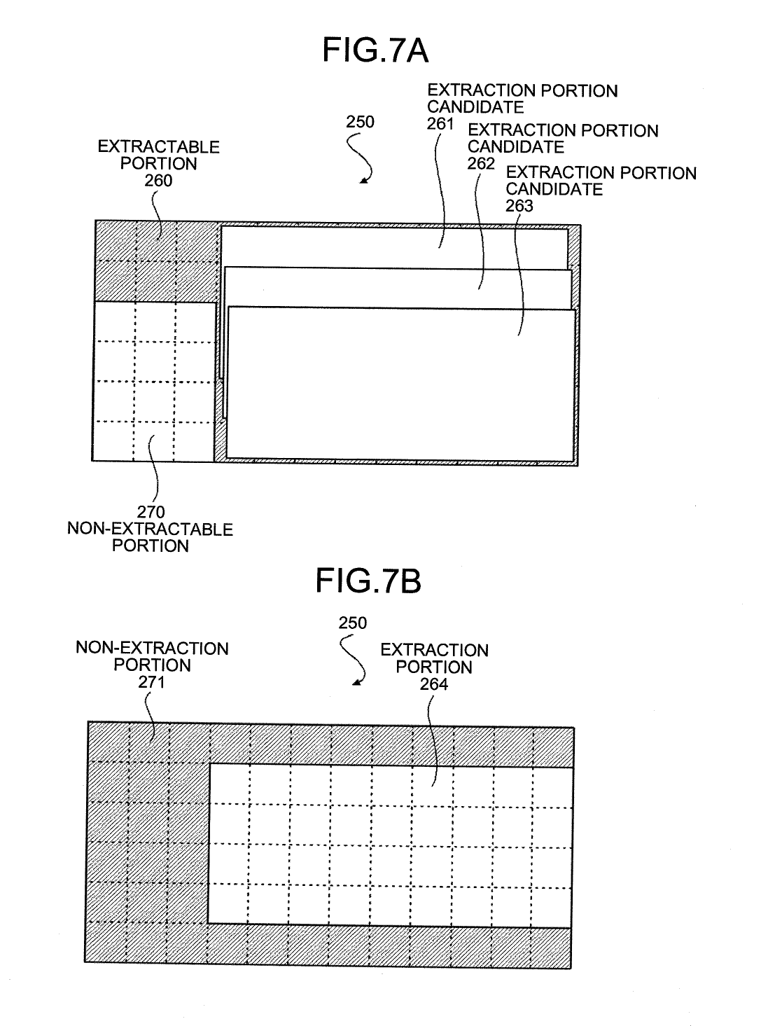

Next, a method of extracting the projection target plane 240 from the projectable plane 230 will be described with reference to FIGS. 7A and 7B.

As described above, the projection target plane 240 is a plane which is extracted from the projectable plane 230 and has the maximum size of the same outer shape as that of the projection target image. Accordingly, the plurality of projection target planes 240 which can be extracted from the projectable plane 230 may present in some cases depending on the outer shape of the projectable plane 230. In this case, the optimum projection target plane 240 is preferably extracted from candidates for the projection target plane 240 which can be extracted from the projectable plane 230. Hereinafter, to facilitate understanding, extraction of an extraction portion 264 corresponding to the projection target plane 240 from the extractable portion 260 corresponding to the projectable plane 230 will be described instead of the extraction of the projection target plane 240 from the projectable plane 230.

FIG. 7A is a diagram illustrating a plurality of extraction portion candidates 261 to 263 which can be extracted from the extractable portion 260. Each of the plurality of extraction portion candidates 261 to 263 is an image which has the same outer shape as that of the projection target image and has the maximum size which can be extracted from the extractable portion 260. Here, the extraction portion 264 is constituted by a collective of the blocks in correspondence with the detection of the projection distance for each block. That is, the size of the extraction portion 264 is defined by the column number of blocks and the row number of blocks. Further, an aspect ratio of the projection target image is assumed to be 9 (the number of pixels in the horizontal direction):4 (the number of pixels in the vertical direction).

In this case, the maximum size of the extraction portion 264 which can be extracted from the extractable portion 260 is 9 (the column number of blocks)×4 (the row number of blocks)=36 blocks. As illustrated in FIG. 7A, here, three extraction portion candidates 261 to 263 are present as the candidates for the extraction portion 264 with a size of “9×4=36 blocks.” Determining one of the extraction portion candidates 261 to 263 as the extraction portion 264 can be appropriately adjusted.

For example, among the extraction portion candidates 261 to 263, the extraction portion which is the closest to the middle in the horizontal direction can be set as the extraction portion 264. In the example illustrated in FIG. 7A, the positions of the extraction portion candidates 261 to 263 in the horizontal direction are all the same. Accordingly, for example, as illustrated in FIG. 7B, the extraction portion which is the closest to the middle in the vertical direction can be set as the extraction portion 264 among the extraction portion candidates 261 to 263. In this case, the extraction portion candidate 262 is determined as the extraction portion 264.

Any method can be used as the method of specifying the extraction portion candidates 261 to 263 from the extractable portion 260. For example, the image projecting apparatus 100 sets, as a comparison target image, an image (for example, an image with substantially the same size as that of the entire image) with a sufficiently large size of the same aspect ratio as that of the projection target image and checks whether the comparison target image completely overlaps the extractable portion 260 by slightly shifting the position of the comparison target image in the horizontal and vertical directions. When the image projecting apparatus 100 does not detect that the comparison target image completely overlaps the extractable portion 260, the image projecting apparatus 100 slightly reduces the size of the comparison target image while maintaining the aspect ratio and again performs the above-described checking using the comparison target image with the reduced size. When the image projecting apparatus 100 detects that the comparison target image completely overlaps the extractable portion 260, the image projecting apparatus 100 specifies the comparison target image as the extraction portion candidates 261 to 263.

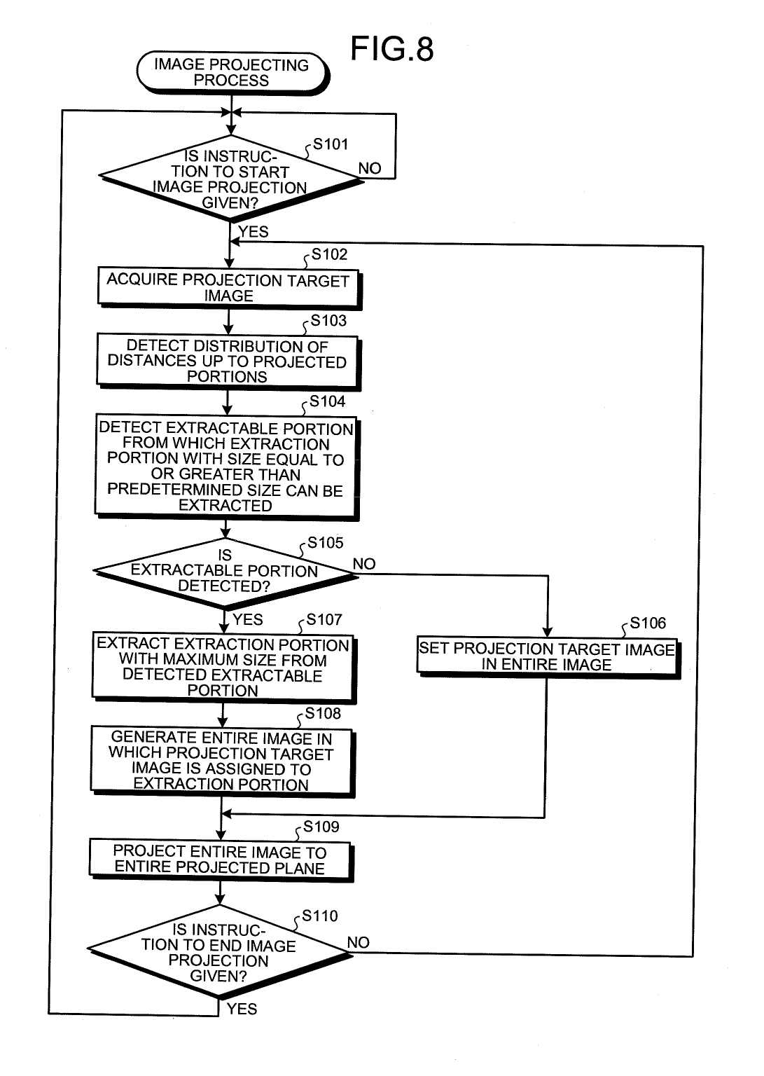

Next, an image projecting process performed by the image projecting apparatus 100 according to the first embodiment will be described with reference to the flowchart illustrated in FIG. 8. When the image projecting apparatus 100 detects that power is input, the image projecting apparatus 100 performs the image projecting process.

First, the CPU 101 determines whether an instruction to start image projection is given (step S101). Specifically, the CPU 101 monitors a control signal supplied from the operation unit 113 and determines whether a user performs an operation indicating the instruction to start the image projection on the operation unit 113. When the CPU 101 determines that the instruction to start the image projection is not given (NO in step S101), the process returns to step S101.

Conversely, when the CPU 101 determines that the instruction to start the image projection is given (YES in step S101), the CPU 101 acquires the projection target image (step S102). For example, the CPU 101 acquires the projection target image from an external apparatus or the storage unit 106 via the communication unit 105 in response to a user's operation or the like on the operation unit 113.

When the process of step S102 is completed or in parallel with the process of step S102, the CPU 101 detects the distribution of the distances up to the projection portions (step S103). Specifically, first, the CPU 101 acquires the results obtained in the projection direction from the distance sensor 112 and obtained by measuring the distances between the projecting lens 110 and the projection portions.

Next, the CPU 101 specifies the projection distances for all of the blocks of the entire image based on the measurement results obtained from the distance sensor 112 and stores the projection distances in correspondence with the blocks in the RAM 103. Through the above described processes, the distribution of the distances between the projecting lens 110 and the projection portions is stored in the RAM 103.

When the process of step S103 ends, the CPU 101 detects the extractable portion 260 from which the extraction portion 264 with a size equal to or greater than a predetermined size can be extracted based on the distribution of the distances stored in the RAM 103 (step S104). Specifically, the CPU 101 determines whether the projection distance is the difference equal to or less the predetermined threshold value with respect to an adjacent block in all of the blocks of the entire image. Then, the CPU 101 specifies the extractable portion 260 constituted by the collective of the blocks of which the projection distance is the difference equal to or less the predetermined threshold value with respect to an adjacent block.

Then, the CPU 101 determines whether there are the extraction portion candidates 261 to 263 that include the number of blocks of a ratio equal to or greater than a predetermined ratio to all of the blocks and have the same aspect ratio as that of the projection target image from the specified extractable portion 260. When the CPU 101 determines that there is at least one of the extraction portion candidates 261 to 263, the CPU 101 detects the specified extractable portion 260 as the extractable portion 260 from which the extraction portion 264 with a size equal to or greater than a predetermined size can be extracted.

For example, the size of the projectable plane 230 is proportional to a product of the size of the extractable portion 260 corresponding to the projectable plane 230 and the projection distance calculated for one of the blocks of the extractable portion 260. Likewise, for example, the size of the projection target plane 240 is proportional to a product of the size of the extraction portion 264 corresponding to the projection target plane 240 and the projection distance calculated for one of the blocks of the extraction portion 264.

When the process of step 5104 ends, the CPU 101 determines whether the above-described extractable portion 260 is detected (step S105). When the CPU 101 determines that the above-described extractable portion 260 is not detected (NO in step S105), the CPU 101 sets the projection target image in the entire image (step S106). That is, the CPU 101 directly projects the projection target image toward the screen 200.

Conversely, when the CPU 101 determines that the above-described extractable portion 260 is detected (YES in step S105), the CPU 101 extracts the extraction portion 264 with the maximum size from the detected extractable portion 260 (step S107). Specifically, the CPU 101 extracts the extraction portion candidates 261 to 263 that have the same aspect ratio as that of the projection target image and include the maximum number of blocks from the detected extractable portion 260. As illustrated in FIG. 7A, when there are the plurality of extraction portion candidates 261 to 263 with the maximum size, for example, the CPU 101 specifies the extraction portion candidate 262 which is the closest to the middle of the entire image 250 as the extraction portion 264 with the maximum size.

When the process of step S107 ends, the CPU 101 generates the entire image 250 in which the projection target image is allocated to the extracted extraction portion 264 with the maximum size (step S108). Specifically, the CPU 101 controls the image processing unit 107 such that the image processing unit 107 generates the projection target image by reducing the projection target image so that the size and position of the projection target image are identical with the size and the position of the extraction portion 264 and setting the other portions to be black.

When the process of step S106 or step S108 ends, the CPU 101 projects the entire image 250 to the entire projection plane 210 (step S109). Specifically, the CPU 101 supplies an image signal indicating the generated entire image 250 from the image processing unit 107 to the display device 109 and outputs the entire image 250 from the projecting lens 110 to the screen 200 by causing the light source 108 to emit light. Further, the CPU 101 controls the optical mechanical unit 111 to adjust the position of the projecting lens 110 so that an image of the light emitted from the projecting lens 110 is formed on the projection target plane 240 corresponding to the extraction portion 264.

When the process of step S109 ends, the CPU 101 determines whether an instruction to end the image projection is given (step S110). Specifically, the CPU 101 monitors a control signal supplied from the operation unit 113 and determines whether the user performs an operation indicating the instruction to end the image projection on the operation unit 113. When the CPU 101 determines that the instruction to end the image projection is not given (NO in step S110), the process returns to step S102. Conversely, when the CPU 101 determines that the instruction to end the image projection is given (YES in step S110), the process returns to step S101.

According to the first embodiment, an image desired to be projected is projected to the plane present in the projection direction and suitable for the projection without change in the projection field angle or the like. For example, the outer shape of the plane suitable for the projection is similar to that of the image desired to be projected, and the plane suitable for the projection is a plane with the maximum ratio by which the image projected to the plane occupies the entire image.

### Second Embodiment

In the first embodiment, the example has been described in which the projection plane is selected focusing on the ratio of the size of the projection plane. In the present invention, the factor focused on when the projection plane is selected can be appropriately adjusted. Hereinafter, an example in which a projection plane is selected focusing on the position of the projection plane will be described. Further, an image projecting apparatus 100 according to a second embodiment is basically the same as the image projecting apparatus 100 according to the first embodiment. Accordingly, differences from those of the first embodiment will be mainly described below.

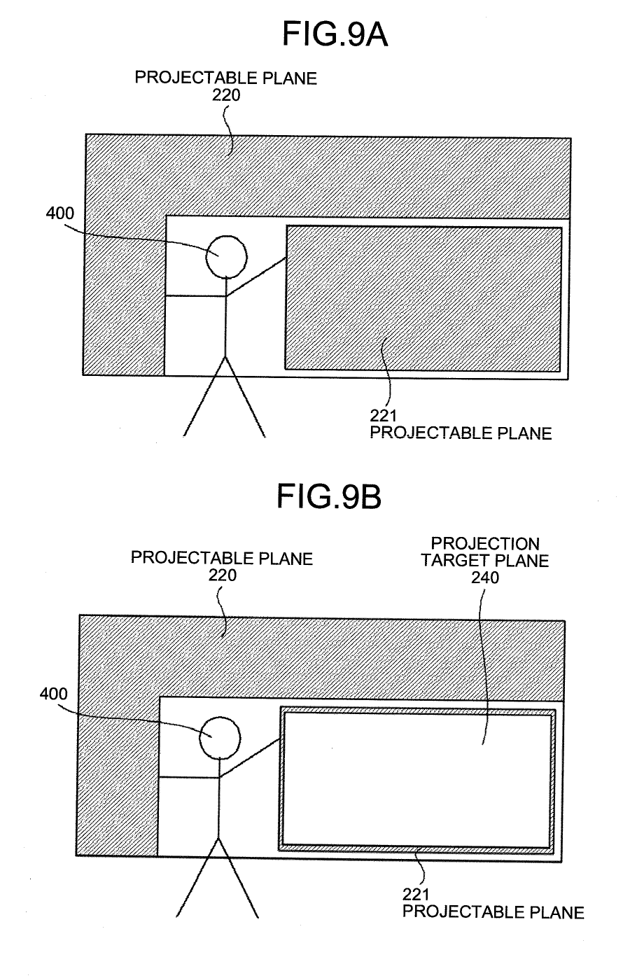

FIG. 9A is a diagram illustrating a state in which a presenter 400 present in the front of a screen 200 is holding a white board or the like which is an image projection target toward the image projecting apparatus 100, instead of the screen 200. In this case, a plane in the front of the white board is preferably set as a projection target rather than a plane of the screen 200 which does not overlap the white board.

First, the image projecting apparatus 100 detects two planes, a projection plane 220 and a projectable plane 221, based on a distribution of projection distances. Thus, when the image projecting apparatus 100 detects the plurality of projection planes 220 and 221, as illustrated in FIG. 9B, the image projecting apparatus 100 extracts a projection target plane 240 from the projectable plane 221 in which the distance up to the image projecting apparatus 100 is the shortest.

The distance between the image projecting apparatus 100 and the projectable plane 221 can be approximated to a projection distance calculated for the block included in the extractable portion which is an image portion corresponding to the projection plane 220 in the entire image 250.

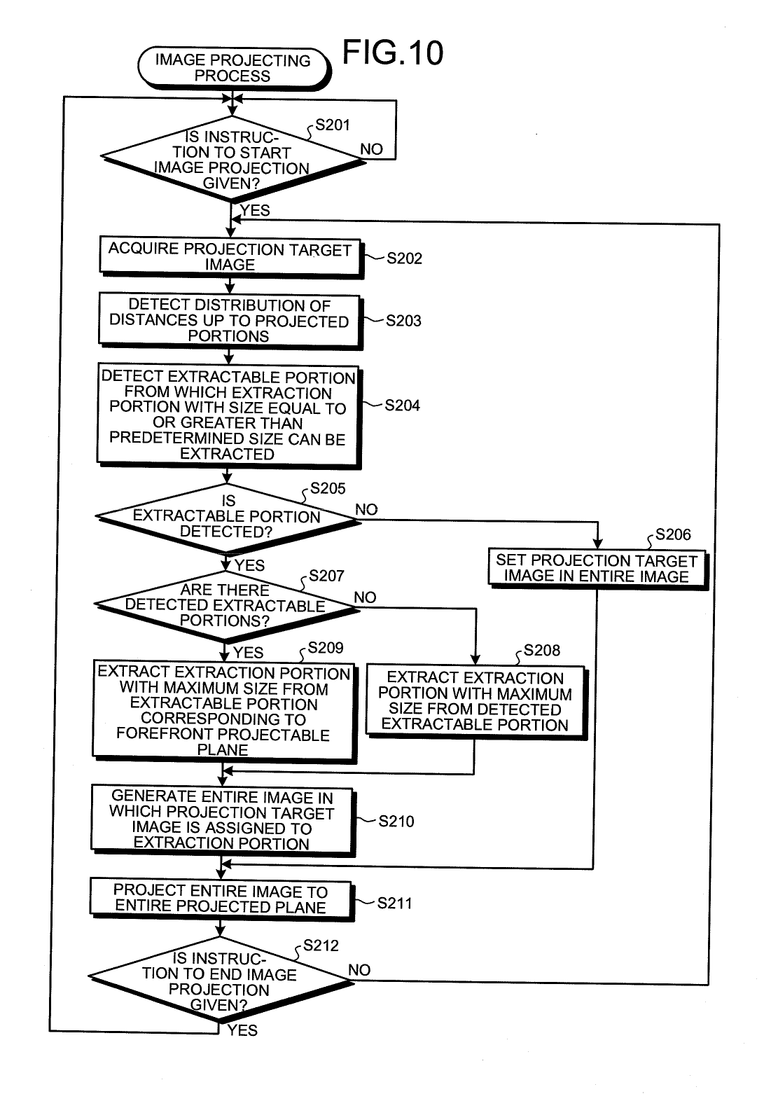

Next, an image projecting process performed by the image projecting apparatus 100 according to the second embodiment will be described with reference to the flowchart illustrated in FIG. 10. When the image projecting apparatus 100 detects that power is input, the image projecting apparatus 100 performs the image projecting process.

First, the CPU 101 determines whether an instruction to start image projection is given (step S201). When the CPU 101 determines that the instruction to start the image projection is not given (NO in step S201), the process returns to step S201.

Conversely, when the CPU 101 determines that the instruction to start the image projection is given (YES in step S201), the CPU 101 acquires the projection target image (step S202).

When the process of step S202 is completed, the CPU 101 detects the distribution of the distances up to the projection portions (step S203).

When the process of step S203 ends, the CPU 101 detects the extractable portion from which the extraction portion with a size equal to or greater than a predetermined size can be extracted based on the distribution of the distances stored in the RAM 103 (step S204).

When the process of step S204 ends, the CPU 101 determines whether the above-described extractable portion is detected (step S205). When the CPU 101 determines that the above-described extractable portion is not detected (NO in step S205), the CPU 101 sets the projection target image in the entire image (step S206). That is, the CPU 101 directly projects the projection target image toward the screen 200.

Conversely, when the CPU 101 determines that the above-described extractable portion is detected (YES in step S205), the CPU 101 determines whether there are the plurality of detected extractable portions (step S207). When the CPU 101 determines that there are no plurality of detected extractable portions (NO in step S207), the CPU 101 extracts the extraction portion with the maximum size from the detected extractable portion (step S208).

Conversely, when the CPU 101 determines that there are the plurality of detected extractable portions (YES in step S207), the CPU 101 extracts the extraction portion with the maximum size from the extractable portion corresponding to the forefront projectable plane 221 (step S209). Specifically, the CPU 101 compares the projection distances detected for the blocks of the extractable portion to each other for each of the plurality of detected extractable portions and specifies the extractable portion with the shortest detected projection distance. Then, the CPU 101 extracts the extraction portion with the maximum size from the specified extractable portion.

When the process of step 5208 or the process of step S209 ends, the CPU 101 generates the entire image 250 in which the projection target image is allocated to the extracted extraction portion with the maximum size (step S210).

When the process of step S206 or step S210 ends, the CPU 101 projects the entire image 250 to the entire projection plane 210 (step S211). Further, the CPU 101 controls the optical mechanical unit 111 to adjust the position of the projecting lens 110 so that an image of the light projected from the projecting lens 110 is formed on the projection target plane 240 corresponding to the extraction portion 264.

When the process of step S211 ends, the CPU 101 determines whether an instruction to end the image projection is given (step S212). When the CPU 101 determines that the instruction to end the image projection is not given (NO in step S212), the process returns to step S202. Conversely, when the CPU 101 determines that the instruction to end the image projection is given (YES in step S212), the process returns to step S201.

According to the second embodiment, an image desired to be projected is projected to the plane present in the projection direction and suitable for the projection without change in the projection field angle or the like. For example, the plane suitable for the projection is present at a location relatively close to the image projecting apparatus 100, the outer shape of the plane suitable for the projection is similar to that of the image desired to be projected, and the plane suitable for the projection is a plane with the maximum ratio by which the image projected to the plane occupies the entire image.

### (Modification Examples)

The present invention is not limited to the embodiments disclosed above.

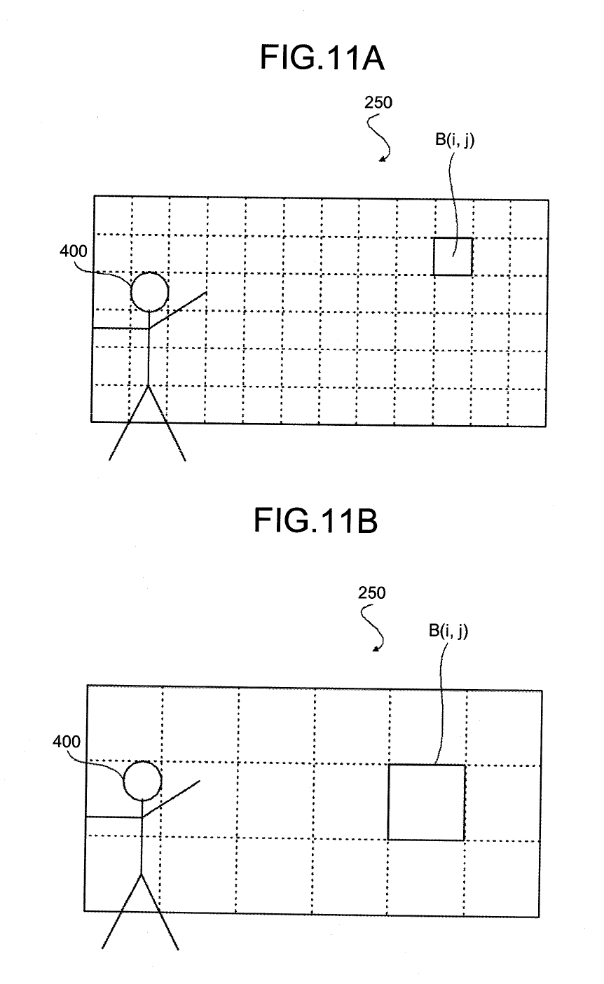

In the first and second embodiments, as illustrated in FIG. 11A, the examples have been described in which the entire image 250 is divided into the large number of relatively small blocks. In the present invention, as illustrated in FIG. 11B, the entire image 250 may be divided into the small number of relatively large blocks.

As illustrated in FIG. 11A, when the entire image 250 is divided into the large number of relatively small blocks, a relatively large plane narrowly avoiding an obstacle can be set as the projection target plane to which the projection target image is projected.

On the other hand, as illustrated in FIG. 11B, when the entire image 250 is divided into the small number of relatively large blocks, a change in the position or size of the projection target plane to which the projection target image is projected can be set to be minimum even in a case in which an obstacle such as the presenter 400 is frequently moving. Therefore, a processing speed can be improved.

The image projecting apparatus 100 can change the size of the bock depending on a situation. For example, when the distribution of the projection distances detected by the distance sensor 112 is considerably changed, the size of the block can be set to be larger. When a change in the distribution of the projection distances is small, the size of the block can be set to be smaller. The degree of change in the distribution of the projection distances is, for example, the number of blocks exceeding the degree of change of the projection distance per unit time in a specific block or a predetermined degree of change in the projection distance per unit time.

In the first and second embodiments, the examples have been described in which the shape of the projection target image or the shape of the projection target plane is the rectangular shape in which the length in the horizontal direction is longer than the length in the vertical direction. In the present invention, any shape of the projection target image or any shape of the projection target plane may be used.

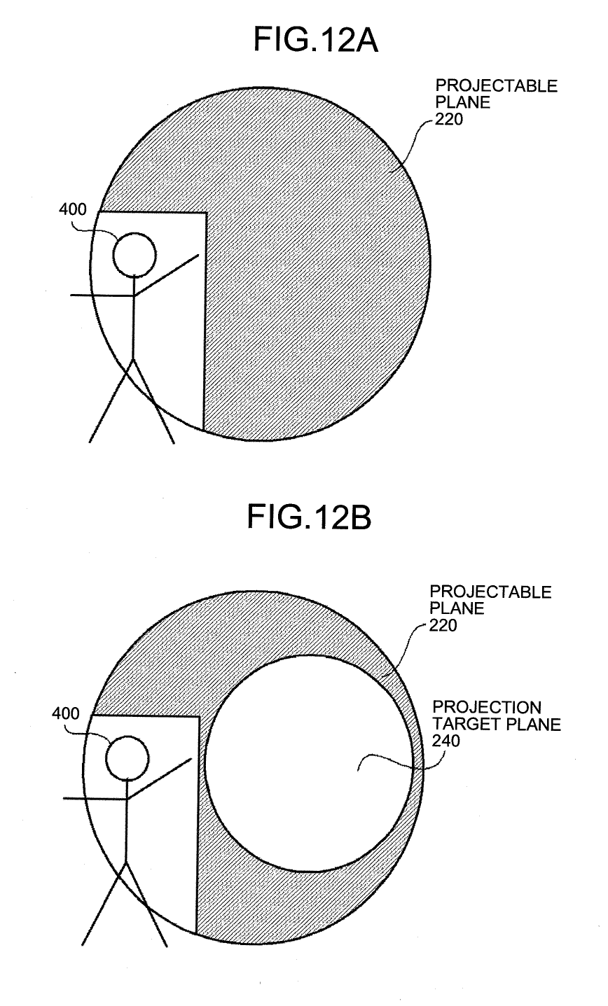

For example, as illustrated in FIG. 12A, the projection target image or the entire image may have a circular shape. In this case, as illustrated in FIG. 12B, the circular projection target plane 240 is extracted from the projection plane 220, and the entire circular projection target image is projected to the circular entire projection target plane 240.

In the first and second embodiments, the examples have been described in which the projectable plane or the projection target plane is a flat plane. In the present invention, the projectable plane or the projection target plane is not limited to the flat plane. For example, the projectable plane or the projection target plane may be an incurve plane in which the projection distance is gradually changed. Even in this case, since the difference between the projection distances detected for two blocks corresponding to the continuous incurve plane is small, the image projecting apparatus 100 can detect the continuous incurve plane.

In the first embodiment, the example has been described in which the extraction portion candidate 262 located in the most middle in the vertical direction is set as the extraction portion 264 among the three extraction portion candidates 261 to 263. The present invention is not limited to this example, when the extraction portion candidate is set as the extraction portion 264. For example, among the three extraction portion candidates 261 to 263, the extraction portion candidate 261 located to be the highest in the vertical direction may be set as the extraction portion 264. In this case, the projection target image is projected to the plane present at a high position at which the projection target image is considered to be viewed relatively easily.

In the first and second embodiments, the examples have been described in which the projectable plane 230 is detected depending on whether the difference between the projection distances obtained for the adjacent blocks is equal to or less than the predetermined range. In the present invention, the method of detecting the projectable plane 230 is not limited to this example. For example, the projectable plane 230 may be detected depending on whether the projection distance detected for each block belongs to one of a plurality of classified groups of the ranges of the projection distances. In this case, the projection distance is preferably corrected according to the position of the block. For example, a block distant from the middle of the entire image can be grouped by multiplying the detected projection distance by a large constant.

In the first embodiment, the example has been described in which the entire plane to which the entire image portion with the maximum occupation ratio thereof to the entire image is projected is specified as the projection target plane. In the present invention, the plane specified as the projection target plane is not limited to this example. For example, one of the entire planes to which entire image portions with an occupation ratio thereof to the entire image is equal to or greater than a predetermined ratio are projected may be specified as the projection target plane. For example, an entire plane to which the entire image portion with an occupation ratio equal to or greater than a predetermined occupation ratio thereof to the entire image and the maximum occupation ratio is projected may be specified as the projection target plane. For example, when there are a plurality of entire planes to which the entire image portions with an occupation ratio equal to or greater than a predetermined occupation ratio thereof to the entire image are projected, the forefront projection target plane may be specified as the projection target plane. That is, in the present invention, the configurations used in the first embodiment, the second embodiment, and the modification examples may be appropriately combined.

In the first and second embodiments, the examples have been described in which the plane with an outer shape similar to that of the projection target image is specified as the projection target plane. In the present invention, the plane specified as the projection target plane is not limited to this example. For example, a plane with an outer shape approximating the outer shape of the projection target image may be specified as the projection target plane.

In the first and second embodiments, the examples have been described in which the portion other than the projection target image in the entire image is the black image. In the present invention, the portion other than the projection target image in the entire image may be an image with another color. In this case, it is preferable to use illuminance or the like of which an influence is small even when the presenter 400 receives the projected light.

In the first and second embodiments, the projection target plane 240 with the same aspect ratio as that of the projection target image has been extracted. However, the projection target image may have a shape with a different aspect ratio depending on setting of the user or a projection target image. In this case, the projection target plane in the projectable plane 230 is preferably set to have the maximum size. In this case, the generating unit 12 generates the projection target image arranged in the entire image by changing the aspect ratio of the projection target image.

In the first embodiment, the example has been described in which the image projecting apparatus 100 includes the CPU 101, the ROM 102, and the RAM 103 and the CPU 101 realizes the image projecting process by software according to the computer program product stored in the ROM 102. However, the image projecting process performed by the image projecting apparatus 100 is not limited to the image projecting process realized by software. For example, the image projecting apparatus 100 may include a microcomputer, an FPGA (Field Programmable Gate Array), a PLD (Programmable Logic Device), or a DSP (Digital Signal Processor).

The image projecting apparatus according to the present invention may be realized by a general computer system rather than a dedicated system. For example, the image projecting apparatus performing the above-described processes may be configured by storing and distributing a computer program product used to execute the above-described processes in a computer-readable recording medium such as a flexible disk, a CD-ROM (Compact Disk-Read Only Memory), a DVD (Digital Versatile Disk), or an MO (Magnet Optical Disk) and installing the computer program product in the computer system. Further, the computer program product may be stored in a disk device or the like of a server apparatus on the Internet and may be downloaded to a computer, for example, by superimposing the computer program product on carrier waves.

According to the aspects of the present invention, it is possible to appropriately display a desired image according to a state of a space in the projection direction of an image.

Although the present invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image projecting apparatus comprising:
a receiving unit that receives a projection target image;
a generating unit that generates an entire image including the projection target image received by the receiving unit;
a projecting unit that projects the entire image generated by the generating unit;
a detecting unit that detects a distribution of distances up to projection portions to which the entire image projected by the projecting unit is actually projected; and
a specifying unit that specifies a projection target plane to which the projection target image is projected based on the distribution of the distances detected by the detecting unit,
wherein the generating unit generates the entire image so that the entire projection target image included in the entire image projected by the projecting unit is projected to the entire projection target plane specified by the specifying unit.

2. The image projecting apparatus according to claim 1, wherein the specifying unit specifies a plane or an incurve plane present in a direction in which the projecting unit projects the entire image based on the distribution of the distances detected by the detecting unit and specifies, as the projection target plane, a plane or an incurve plane which is extracted from the specified plane or the specified incurve plane and in which an entire partial image having an area equal to or greater than a predetermined ratio in the entire image is projected to an entirety.

3. The image projecting apparatus according to claim 1, wherein the specifying unit specifies a plane or an incurve plane present in a direction in which the projecting unit projects the entire image based on the distribution of the distances detected by the detecting unit and specifies, as the projection target plane, a plane or an incurve plane which is extracted from the specified plane or the specified incurve plane and in which an entire partial image having a maximum area in the entire image is projected to an entirety.

4. The image projecting apparatus according to claim 1, wherein the specifying unit specifies a plane or an incurve plane present in a direction in which the projecting unit projects the entire image based on the distribution of the distances detected by the detecting unit and specifies, as the projection target plane, a plane or an incurve plane which is extracted from the specified plane or the specified incurve plane and which is closest.

5. The image projecting apparatus according to claim 1, wherein in the entire image generated by the generating unit, a portion other than a portion indicating the projection target image received by the receiving unit is an image, such as a black image, which is not displayed by the projection.

6. An image projecting method comprising:
receiving a projection target image;
generating an entire image including the projection target image received in the receiving of the projection target image;
projecting the entire image generated in the generating of the entire image;
detecting a distribution of distances up to projection portions to which the entire image projected in the projecting of the entire image is actually projected; and
specifying a projection target plane to which the projection target image is projected based on the distribution of the distances detected by the detecting of the distribution of distances,
wherein in the generating of the entire image, the entire image is generated so that the entire projection target image included in the entire image projected in the projecting of the entire image is projected to the entire projection target plane specified in the specifying of the projection target plane.

7. A computer program product causing a computer to function as:
a receiving unit that receives a projection target image;
a generating unit that generates an entire image including the projection target image received by the receiving unit;
a projecting unit that projects the entire image generated by the generating unit;
a detecting unit that detects a distribution of distances up to projection portions to which the entire image projected by the projecting unit is actually projected; and
a specifying unit that specifies a projection target plane to which the projection target image is projected based on the distribution of the distances detected by the detecting unit,
wherein the generating unit generates the entire image so that the entire projection target image included in the entire image projected by the projecting unit is projected to the entire projection target plane specified by the specifying unit.
